(19) United States
(12) Patent Application Publication
(10) Pub. No.: US 2026/0093169 A1
(43) Pub. Date: Apr. 2, 2026

(54) ILLUMINATION DEVICE AND PROJECTOR

(71) Applicant: SEIKO EPSON CORPORATION, Tokyo (JP)

(72) Inventor: Masanori YASUDA, MATSUMOTO-SHI (JP)

(21) Appl. No.: 19/339,764

(22) Filed: Sep. 25, 2025

(30) Foreign Application Priority Data
Sep. 27, 2024 (JP) 2024-168294

(51) Int. Cl. G03B 21/20

(52) U.S. Cl. CPC G03B 21/204

(57) ABSTRACT

An illumination device according to the present disclosure includes a light source, a light separation element that separates first light incident from the light source into transmitted light and reflected light, a wavelength conversion element that converts the transmitted light into second light, and a first reflection element that reflects the reflected light toward the light separation element. The light separation element includes a light-transmissive substrate having a first surface and a second surface, a first optical layer disposed at the first surface and configured to transmit a first component of the first light and reflect a second component of the first light, and a second optical layer disposed at the second surface and configured to transmit a third component in the first component having reached the second surface and reflect a fourth component in the first component. The first light is incident on the first surface from a direction crossing the direction along the principal surface of the first surface and the normal direction of the principal surface, the first optical layer transmits the fifth component in the fourth component incident from the second optical layer, and the second component and the fifth component are incident on the first reflection element as the reflected light.

The present application is based on, and claims priority from JP Application Serial Number 2024-168294, filed Sep. 27, 2024, the disclosure of which is hereby incorporated by reference herein in its entirety.

### BACKGROUND

### 1. Technical Field

The present disclosure relates to an illumination device and a projector.

### 2. Related Art

JP-A-2016-145965 discloses an illumination device that multiply-reflects a laser beam emitted from a light source unit to thereby increase the number of luminous fluxes in the reflected light, and then causes the laser beam to enter a diffusion element in this state to thereby suppress luminance unevenness in a projected image.

JP-A-2016-145965 is an example of the related art.

Since a configuration which multiply-reflects the light from the light source to extract only the reflected light is adopted in a mirror used in the illumination device described above, there is a problem that design freedom in the light path of the light emitted from the light source is limited and the in-plane illuminance unevenness of the reflected light thus extracted increases.

### SUMMARY

In order to solve the problem described above, according to a first aspect of the present disclosure, there is provided an illumination device including a light source configured to emit first light in a first wavelength band, a light separation element configured to separate the first light incident from the light source into transmitted light and reflected light, a wavelength conversion element configured to convert the transmitted light separated by the light separation element into second light in a second wavelength band different from the first wavelength band, and a first reflection element configured to reflect, toward the light separation element, the reflected light separated by the light separation element, in which the light separation element includes a light-transmissive substrate having a first surface and a second surface that are parallel to each other and face to respective directions opposite to each other, a first optical layer that is disposed at the first surface, transmits a first component that is a part of the first light incident from the light source, and reflects a second component that is another part of the first light, and a second optical layer that is disposed at the second surface, transmits a third component that is a part of the first component that was transmitted through the first surface and reached the second surface, and reflects a fourth component that is another part of the first component, the first light is incident on the first surface of the light-transmissive substrate from a direction crossing a direction along a principal surface of the first surface and a normal direction of the principal surface, the first optical layer is configured to transmit a fifth component that is a part of the fourth component incident from the second optical layer, and the second component reflected by the first optical layer and the fifth component transmitted through the first optical layer are incident on the first reflection element as the reflected light.

According to a second aspect of the present disclosure, there is provided a projector including the illumination device according to the first aspect, a light modulation device configured to modulate light incident from the illumination device, and a projection optical device configured to project the light modulated by the light modulation device.

### BRIEF DESCRIPTION OF THE DRAWINGS

FIG. 1 shows a schematic configuration of a projector according to a first embodiment.

FIG. 2 is a diagram showing a schematic configuration of an illumination device according to a first embodiment.

FIG. 3 is a cross-sectional view showing a configuration of an essential part of a light separation element.

FIG. 4 is a plan view of blue illumination light viewed from a direction along an optical axis.

FIG. 5 is a diagram showing a behavior of light in consideration of refraction in a light-transmissive substrate.

FIG. 6 is a diagram showing a schematic configuration of an illumination device according to a second embodiment.

### DESCRIPTION OF EMBODIMENTS

### First Embodiment

A first embodiment of the present disclosure will hereinafter be described with reference to the drawings.

The projector according to the first embodiment is an example of a liquid crystal projector including an illumination device and three light modulation devices.

A specific description will hereinafter be presented using the drawings, and in the drawings described below, elements may be illustrated at different dimensional scales in accordance with the elements in some cases in order to make the elements eye-friendly.

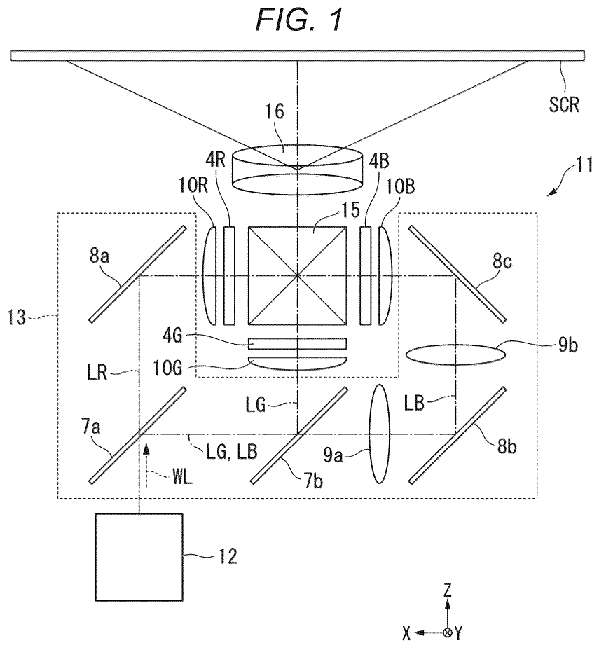

FIG. 1 is a diagram showing a schematic configuration of a projector according to the present embodiment.

As shown in FIG. 1, the projector 11 according to the present embodiment is a projection-type image display apparatus that displays a color image on a screen SCR. The projector 11 includes three light modulation devices 4B, 4G, and 4R corresponding respectively to colored light of red light LR, green light LG, and blue light LB. The projector 11 uses, as a light source of an illumination device 12, a semiconductor laser capable of providing high-luminance and high-power light.

The projector 11 includes the illumination device 12, a color separation optical system 13, a red-light modulation device 4R, a green-light modulation device 4G, and a blue-light modulation device 4B, a combining optical system 15, and a projection optical device 16.

The illumination device 12 emits illumination light WL having a uniform illuminance distribution toward the color separation optical system 13. As the illumination device 12, a light source device as an embodiment of the present disclosure is used.

The color separation optical system 13 separates the illumination light WL emitted from the illumination device 12 into the red light LR, the green light LG, and the blue light LB. The color separation optical system 13 includes a first dichroic mirror 7a, a second dichroic mirror 7b, a first reflecting mirror 8a, a second reflecting mirror 8b, a third reflecting mirror 8c, a first relay lens 9a, and a second relay lens 9b.

The first dichroic mirror 7a has a function of separating the illumination light WL emitted from the illumination device 12 into the red light LR, the green light LG, and the blue light LB. The first dichroic mirror 7a transmits the red light LR and reflects the green light LG and the blue light LB. The second dichroic mirror 7b has a function of separating the light reflected by the first dichroic mirror 7a into the green light LG and the blue light LB. The second dichroic mirror 7b reflects the green light LG and transmits the blue light LB.

The first reflecting mirror 8a is disposed in a light path of the red light LR. The first reflecting mirror 8a reflects, toward the red-light modulation device 4R, the red light LR transmitted through the first dichroic mirror 7a. The second reflecting mirror 8b and the third reflecting mirror 8c are disposed in a light path of the blue light LB. The second reflecting mirror 8b and the third reflecting mirror 8c reflect, toward the blue-light modulation device 4B, the blue light LB transmitted through the second dichroic mirror 7b. The green light LG is reflected by the second dichroic mirror 7b and travels toward the green-light modulation device 4G.

The first relay lens 9a and the second relay lens 9b are disposed at a light exit side of the second dichroic mirror 7b in the light path of the blue light LB. The first relay lens 9a and the second relay lens 9b compensate for an optical loss of the blue light LB resulting from the fact that the light path length of the blue light LB is longer than the light path lengths of the red light LR and the green light LG.

The red-light modulation device 4R modulates the red light LR in accordance with image information to form image light corresponding to the red light LR. The green-light modulation device 4G modulates the green light LG in accordance with the image information to form image light corresponding to the green light LG. The blue-light modulation device 4B modulates the blue light LB in accordance with the image information to form image light corresponding to the blue light LB.

Transmissive liquid crystal panels, for example, are used as the red-light modulation device 4R, the green-light modulation device 4G, and the blue-light modulation device 4B. Further, a pair of polarizing plates (not shown) are disposed at the incident side and the exit side of the liquid crystal panel, respectively. The pair of polarizing plates transmit linearly polarized light in a specific polarization direction.

A field lens 10R is disposed at the incident side of the red-light modulation device 4R. A field lens 10G is disposed at the incident side of the green-light modulation device 4G. A field lens 10B is disposed at the incident side of the blue-light modulation device 4B. The field lens 10R collimates the red light LR to be incident on the red-light modulation device 4R. The field lens 10G collimates the green light LG to be incident on the green-light modulation device 4G. The field lens 10B collimates the blue light LB to be incident on the blue-light modulation device 4B.

The combining optical system 15 combines the image light corresponding to the red light LR, the image light corresponding to the green light LG, and the image light corresponding to the blue light LB with each another and emits the combined image light toward the projection optical device 16. A cross dichroic prism, for example, is used as the combining optical system 15.

The projection optical device 16 is formed of a projection lens group including a plurality of projection lenses. The projection optical device 16 projects the image light combined by the combining optical system 15 toward the screen SCR in an enlarged manner. Thus, a color image thus enlarged is displayed on the screen SCR.

The illumination device 12 will hereinafter be described.

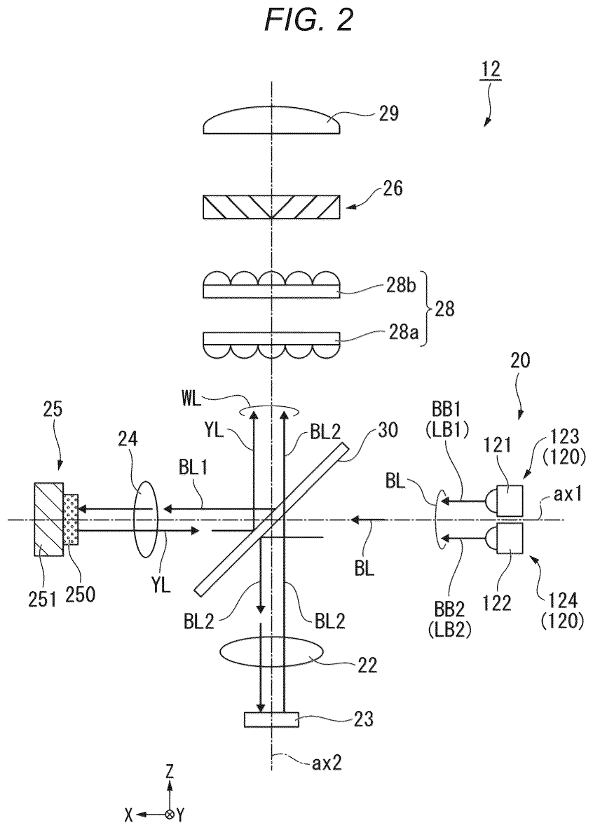

FIG. 2 is a diagram illustrating a schematic configuration of the illumination device 12 according to the present embodiment.

As shown in FIG. 2, the illumination device 12 includes a light source 20, a light separation element 30, a first pickup optical system 22, a diffuse reflection element 23, a second pickup optical system 24, a wavelength conversion element 25, an integrator optical system 28, a polarization conversion element 26, and a superimposing lens 29.

A configuration of a light source device will hereinafter be described using an X-Y-Z orthogonal coordinate system. A central axis of the blue light BL emitted from the light source 20 is referred to as an optical axis ax1. An axis along the optical axis ax1 is defined as an X axis, a side to which the blue light BL is emitted is referred to as a +X side, and an opposite side to the +X side is referred to as a −X side. The central axis of blue illumination light BL2 emitted from the diffuse reflection element 23 is referred to as an optical axis ax2. An axis along the optical axis ax2 is defined as a Z axis, a side to which the blue illumination light BL2 is emitted is referred to as a +Z side, and an opposite side to the +Z side is referred to as a −Z side. An axis perpendicular to the X axis and the Z axis is defined as a Y axis, one side along the Y axis is referred to as a +Y side, and an opposite side to the +Y side is referred to as a −Y side.

Out of the elements described above, the light source 20, the light separation element 30, the second pickup optical system 24, and the wavelength conversion element 25 are arranged side by side on the optical axis ax1. The diffuse reflection element 23, the first pickup optical system 22, the light separation element 30, the integrator optical system 28, the polarization conversion element 26, and the superimposing lens 29 are arranged side by side on an optical axis ax2. The optical axes ax1 and ax2 are perpendicular to each other in the same plane.

The light source 20 according to the present embodiment includes a plurality of light emitting units 120. The plurality of light emitting units 120 includes a first light emitting unit array 123 in which a plurality of first light emitting units 121 is arranged, and a second light emitting unit array 124 in which a plurality of second light emitting units 122 is arranged. In the case of the present embodiment, the first light emitting unit array 123 is configured with four first light emitting units 121 arranged along the Y-axis direction. The second light emitting unit array 124 is configured with four second light emitting units 122 arranged along the Y-axis direction. Second light emitting unit array 124 is disposed in parallel to the first light emitting unit array 123 in the Z-axis direction.

The first light emitting unit 121 is formed of, for example, a semiconductor laser (Laser Diode; LD) that emits blue light having a peak wavelength in a wavelength band of 380 nm to 495 nm. Therefore, the first light emitting unit array 123 emits a first luminous flux LB1 including four blue light beams BB1 arranged in the Y-axis direction.

Similarly to the first light emitting unit 121, the second light emitting unit 122 is formed of, for example, a semiconductor laser that emits blue light having a peak wavelength in the wavelength band of 380 nm to 495 nm. Therefore, the second light emitting unit array 124 emits a second luminous flux LB2 including four blue light beams BB2 arranged in the Y-axis direction.

Based on such a configuration, the light source 20 emits, along the optical axis ax1, the blue light BL configured with the first luminous flux LB1 and the second luminous flux LB2 including the plurality of blue light beams BB1, BB2. The blue light BL in the present embodiment corresponds to an example of “first light in a first wavelength band” in the present disclosure.

The blue light BL emitted from the light source 20 enters the light separation element 30. The light separation element 30 in the present embodiment forms an angle of 45° with the optical axis ax1 and the optical axis ax2. The light separation element 30 transmits a part of the blue light BL and reflects another part of the blue light BL. A component corresponding to the part of the blue light BL transmitted through the light separation element 30 enters the wavelength conversion element 25, and a component corresponding to the another part of the blue light BL reflected by the light separation element 30 enters the diffuse reflection element 23. In the following description, the component of the blue light BL that is transmitted through the light separation element 30 and is incident on the wavelength conversion element 25 is used to excite the phosphor layer, and is therefore referred to as excitation light BL1. The component of the blue light BL incident on the diffuse reflection element 23 is used as a part of the blue light in the illumination light, and is therefore referred to as blue illumination light BL2. The excitation light BL1 in the present embodiment corresponds to an example of “transmitted light” in the present disclosure, and the blue illumination light BL2 corresponds to “reflected light” in the present disclosure.

In this manner, the light separation element 30 separates the blue light BL incident from the light source 20 into the excitation light BL1 and the blue illumination light BL2. Further, the light separation element 30 reflects yellow fluorescence YL different in wavelength band from the blue light BL. Note that details of the configuration of the light separation element 30 will be described later.

The excitation light BL1 transmitted through the light separation element 30 is incident on the second pickup optical system 24. The second pickup optical system 24 condenses the excitation light BL1 toward a phosphor layer 250 of the wavelength conversion element 25. The second pickup optical system 24 is formed of a single lens or a plurality of lenses.

The wavelength conversion element 25 includes the phosphor layer 250 and a substrate 251 which supports the phosphor layer 250. When the excitation light BL1 enters the phosphor layer 250, a phosphor contained in the phosphor layer 250 is excited, and the yellow fluorescence YL having a wavelength band different from the wavelength band of the excitation light BL1 is generated. A heat sink for dissipating heat of the phosphor layer 250 may be disposed at a surface of the substrate 251 different from the surface at which the phosphor layer 250 is disposed. The fluorescence YL in the present embodiment corresponds to an example of “second light in a second wavelength band” in the present disclosure.

A material of the phosphor layer 250 includes, for example, an yttrium-aluminum-garnet-based (YAG-based) phosphor. Citing YAG:Ce, which contains cerium (Ce) as an activator, as an example, a material obtained by mixing raw powder materials containing elements such as Y₂O₃, Al₂O₃, or CeO₃, and then being subjected to a solid-phase reaction, Y—Al—O amorphous particles obtained by a wet method such as a coprecipitation method or a sol-gel method, or YAG particles obtained by a gas-phase method such as a spray-drying method, a flame heat decomposition method, or a thermal plasma method, and so on are used as a material of the phosphor layer 250.

The fluorescence YL emitted from the phosphor layer 250 is collimated by the second pickup optical system 24 and then enters the light separation element 30. The fluorescence YL is reflected by the light separation element 30 and travels toward the integrator optical system 28. The fluorescence YL is scattered when being emitted from the phosphor layer 250, and therefore has a more uniform illuminance distribution than that of the excitation light BL1.

Meanwhile, the blue illumination light BL2 reflected by the light separation element 30 is incident on the first pickup optical system 22. Since the blue illumination light BL2 passes through the light separation element 30 as will be described later, the number of blue light beams forming the blue illumination light BL2 is doubled compared to that before the blue illumination light BL2 is incident on the light separation element 30. Accordingly, it is possible to suppress illuminance unevenness of the blue illumination light BL2 separated from the blue light BL formed of the laser beam.

The first pickup optical system 22 condenses the blue illumination light BL2 toward the diffuse reflection element 23. The first pickup optical system 22 is formed of a single lens or a plurality of lenses. The diffuse reflection element 23 in the present embodiment corresponds to an example of a “first reflection element” in the present disclosure.

The diffuse reflection element 23 diffusely reflects, toward the light separation element 30, the blue illumination light BL2 emitted from the first pickup optical system 22. In particular, it is preferable to use, as the diffuse reflection element 23, a diffuse reflection element that causes Lambertian reflection of the blue illumination light BL2 incident on the diffuse reflection element 23.

The diffuse reflection element 23 includes a substrate, a metal reflection film, and a dielectric multilayer film. The substrate is formed of, for example, a metal plate having a predetermined rigidity, and an uneven structure including a plurality of recesses and a plurality of protrusions is provided over a surface of the substrate. The metal reflection film is provided along the uneven structure of the substrate. The metal reflection film is made of, for example, a material containing aluminum. The dielectric multilayer film is disposed at an opposite surface of the metal reflection film to the substrate. The dielectric multilayer film has a configuration in which two types of dielectric films different in refractive index from each other are alternately stacked on one another a plurality of times.

By using the diffuse reflection element 23 of this type, the illumination device 12 of the present embodiment can obtain the blue illumination light BL2 having a uniform illuminance distribution while diffusely reflecting the blue illumination light BL2.

The blue illumination light BL2 diffusely reflected by the diffuse reflection element 23 is collimated by the first pickup optical system 22 and then enters the light separation element 30. The blue illumination light BL2 is transmitted through the light separation element 30 and travels toward the integrator optical system 28. Note that a part of the blue illumination light BL2 is reflected by the light separation element 30 and returns to the light source 20.

In the case of the present embodiment, since the blue illumination light BL2 is diffusely reflected by the diffuse reflection element 23, in-plane illuminance distribution is made more uniform. Therefore, since the blue illumination light BL2 has a uniform illuminance distribution, the luminance unevenness is suppressed.

Note that when the number of blue light beams forming the blue illumination light BL2 is small, there is a possibility that a variation in unevenness due to the unevenness of the diffuse reflection element 23 is reflected on the screen SCR. In contrast, in the case of the present embodiment, since the number of blue light beams forming the blue illumination light BL2 is increased as described later, it is possible to suppress degradation in image quality due to the reflection of the variation in unevenness.

In this way, the blue illumination light BL2 is used as the illumination light WL together with the fluorescence YL reflected by the light separation element 30. That is, the blue illumination light BL2 and the fluorescence YL are emitted from the light separation element 30 in the same direction toward the +Z side. The fluorescence YL has a uniform illuminance distribution. In this way, the blue illumination light BL2 and the yellow fluorescence YL each having a uniform illuminance distribution are combined with each other, and thus, the white illumination light WL having a uniform illuminance distribution can be obtained.

That is, the light separation element 30 also functions as a color combining element that combines the blue illumination light BL2 and the fluorescence YL with each other.

The illumination light WL emitted from the light separation element 30 enters the integrator optical system 28. The integrator optical system 28 divides the illumination light WL into a plurality of small luminous fluxes. The integrator optical system 28 is formed of a first lens array 28a and a second lens array 28b. Each of the first lens array 28a and the second lens array 28b has a configuration in which a plurality of microlenses is arranged in an array.

The illumination light WL emitted from the integrator optical system 28 enters the polarization conversion element 26. The polarization conversion element 26 uniforms the polarization directions of the illumination light WL. The polarization conversion element 26 is configured with polarization splitting films and wave plates. The polarization conversion element 26 uniforms the polarization direction of the fluorescence YL as unpolarized light and the polarization direction of the blue illumination light BL2 as linearly polarized light in one direction. In the case of the present embodiment, the polarization conversion element 26 uniforms the polarization direction of the illumination light WL into the polarization direction according to the light transmission axis of the polarization plate disposed at the light incident side of each of the liquid crystal panels of the red-light modulation device 4R, the green-light modulation device 4G, and the blue-light modulation device 4B.

The illumination light WL polarization direction of which has been uniformed by passing through the polarization conversion element 26 enters the superimposing lens 29. The superimposing lens 29 superimposes the plurality of small luminous fluxes emitted from the polarization conversion element 26 on each other at the illumination target object. Accordingly, the illumination target object can uniformly be illuminated.

Then, a configuration of the light separation element 30 will be described.

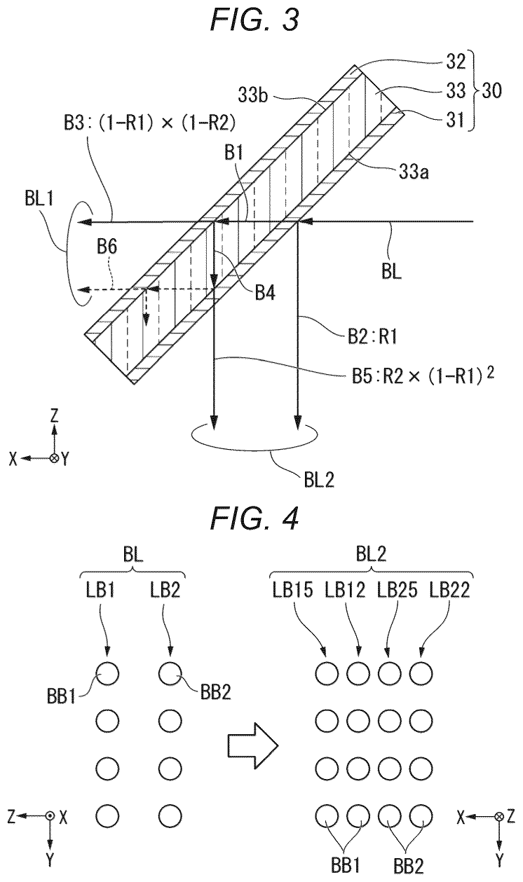

FIG. 3 is a cross-sectional view showing a configuration of an essential part of the light separation element 30. In order to simplify the description, FIG. 3 illustrates a state in which refraction of light at the time of incidence on the light separation element 30 or at the time of exit from the light separation element 30 is not considered.

As shown in FIG. 3, the light separation element 30 includes a first optical layer 31, a second optical layer 32, and a light-transmissive substrate 33. The light-transmissive substrate 33 is made of optical glass such as BK7. The light-transmissive substrate 33 has a first surface 33a and a second surface 33b that are parallel to each other and face to respective directions opposite to each other.

The blue light BL enters the first surface 33a of the light-transmissive substrate 33 from a direction crossing a direction along a principal surface of the first surface 33a and the normal direction of the first surface 33a. In the present embodiment, the light separation element 30 is disposed in a state of being inclined with respect to the optical axis ax1. Therefore, since the blue light BL is incident on the first optical layer 31 and the second optical layer 32 of the light separation element 30 from an oblique direction, by the blue light BL passing through the first optical layer 31 and the second optical layer 32 as described later, the light path of the blue light BL is separated into two.

The first optical layer 31 is disposed at the first surface 33a of the light-transmissive substrate 33.

The first optical layer 31 is formed of a dielectric multilayer film having an optical characteristic of transmitting a part of the light in the blue wavelength band and reflecting another part thereof. Therefore, the first optical layer 31 transmits a first component B1, which is a part of the blue light BL incident from the light source 20, and reflects a second component B2, which is another part of the blue light BL. Accordingly, the second component B2 is emitted from the light separation element 30 toward the diffuse reflection element 23.

The first component B1 transmitted through the first optical layer 31 is transmitted through the light-transmissive substrate 33 from the first surface 33a and reaches the second surface 33b. The second optical layer 32 is disposed at the second surface 33b of the light-transmissive substrate 33. The second optical layer 32 is formed of a dielectric multilayer film having an optical characteristic of transmitting a part of the blue light BL in the blue wavelength band and reflecting another part of the blue light BL and the fluorescence YL in the yellow wavelength band. Therefore, the second optical layer 32 transmits a third component B3, which is a part of the first component B1 having been transmitted through the first surface 33a and having reached the second surface 33b, and reflects a fourth component B4, which is another part of the first component B1. Thus, the third component B3 is emitted from the light separation element 30 toward the wavelength conversion element 25.

The fourth component B4 reflected by the second optical layer 32 is transmitted through the light-transmissive substrate 33 from the first surface 33a and then enters the first optical layer 31 disposed at the first surface 33a. The first optical layer 31 transmits a fifth component B5 that is a part of the fourth component B4 incident from the second optical layer 32. Accordingly, the fifth component B5 is emitted from the light separation element 30 toward the diffuse reflection element 23.

In this way, the light separation element 30 can cause the second component B2 and the fifth component B5 separated from the blue light BL to enter the diffuse reflection element 23 as the blue illumination light BL2 described above. Further, the light separation element 30 can cause the third component B3 and a sixth component B6 separated from the blue light BL to enter the wavelength conversion element 25 as the excitation light BL1 described above.

The fluorescence YL generated by the wavelength conversion element 25 is collimated by the second pickup optical system 24 as described above and enters the light separation element 30. Therefore, the fluorescence YL enters the second surface 33b from the wavelength conversion element 25 in an oblique direction, and is reflected by the second optical layer 32 disposed at the second surface 33b to be emitted in the Z-axis direction which is different from the Z-axis direction in which the fluorescence YL enters the second optical layer 32.

As shown in FIG. 3, another part of the fourth component B4 incident on the first optical layer 31 is reflected to be incident on the second optical layer 32, and a part thereof is transmitted through the second optical layer 32 and is then emitted from the light separation element 30 toward the wavelength conversion element 25 as the sixth component B6. Note that another part of the fourth component B4 reflected by the first optical layer 31 is reflected by the second optical layer 32 to be incident on the first optical layer 31, and is transmitted through the first optical layer 31, and is then transmitted through the first optical layer 31 to be reflected from the light separation element 30 toward the diffuse reflection element 23, but is much less than the second component B2 and the fifth component B5, and thus does not cause a problem such as illuminance unevenness.

For example, it is assumed that the reflectances of the first optical layer 31 and the second optical layer 32 of the light separation element 30 are R1 and R2, respectively, and the amount of the blue light BL incident on the light separation element 30 from the light source 20 is 1.

In this case, the light amount of the second component B2 can be defined as R1, the light amount of the fifth component B5 can be defined as R2×(1−R1)², and the light amount of the third component can be defined as (1−R1)×(1−R2).

Here, when a difference in light amount between the second component B2 and the fifth component B5 becomes too large, the illuminance unevenness of the blue illumination light BL2 becomes large, and thus the quality of the projected image is degraded. In contrast, in the light separation element 30 in the present embodiment, a ratio in light amount between the second component B2 and the fifth component B5 is set in a range of 50% to 200%. It is the most preferable when the ratio in light amount between the second component B2 and the fifth component B5 is 100%, that is, when the second component B2 and the fifth component B5 are equal in light amount. Note that when the relational expression of R2=R1/(1−R1)² is satisfied, the second component B2 and the fifth component B5 are equal in light amount to each other.

In the light separation element 30 in the present embodiment, the reflectance R2 of the blue light BL in the second optical layer 32 is higher than the reflectance R1 of the blue light BL in the first optical layer 31. According to this configuration, it is possible to increase the proportion of the blue light BL which reaches the second optical layer 32 by increasing the transmittance of the blue light BL in the first optical layer 31. Accordingly, it is possible to prevent the light amount of the second component B2 from being excessively higher than the light amount of the fifth component B5.

For example, when the reflectance R1 of the first optical layer 31 is 13.0% and the reflectance R2 of the second optical layer 32 is 17.2%, the light amounts of the second component B2 and the fifth component B5 can be made equal to 13.0% with respect to the light amount of 100% of the blue light BL.

FIG. 4 is a plan view of the blue illumination light BL2 emitted from the light separation element 30 viewed from a direction along the optical axis ax2. For comparison, FIG. 4 shows a plan view of the blue light BL incident on the light separation element 30 viewed from a direction along the optical axis ax1.

As shown in FIG. 4, the blue light BL in the present embodiment includes the four blue light beams BB1 forming the first luminous flux LB1 and the four blue light beams BB2 forming the second luminous flux LB2. That is, in the case of the present embodiment, the blue light BL is formed of the eight blue light beams.

Meanwhile, the blue illumination light BL2 separated from the blue light BL by the light separation element 30 includes a luminous flux LB12 corresponding to the second component B2 of the first luminous flux LB1, a luminous flux LB15 corresponding to the fifth component B5 of the first luminous flux LB1, a luminous flux LB22 corresponding to the second component B2 of the second luminous flux LB2, and a luminous flux LB25 corresponding to the fifth component B5 of the second luminous flux LB2. Each of the luminous fluxes LB12, LB15, LB22, and LB25 includes the four blue light beams. Therefore, the blue illumination light BL is configured with 16 blue light beams.

In the case of the present embodiment, as shown in FIG. 4, the luminous fluxes LB15, LB25 corresponding to the fifth component B5 in the blue light BL (the first luminous flux LB1 and the second luminous flux LB2) emitted from the first light emitting unit array 123 and the second light emitting unit array 124 are shifted toward the +X side in the X-axis direction in which the luminous fluxes LB12, LB22 corresponding to the second component B2 in the blue light BL (the first luminous flux LB1 and the second luminous flux LB2) emitted from the first light emitting unit array 123 and the second light emitting unit array 124 are arranged. Further, the luminous fluxes LB15, LB25 are disposed at positions not overlapping each of the luminous fluxes LB12, LB22.

The luminous fluxes LB12, LB22 corresponding to the second component B2 and the luminous fluxes LB15, LB25 corresponding to the fifth component B5 are arranged in the X-axis direction. The four blue light beams forming each of the luminous fluxes LB12, LB15, LB22, and LB25 are arranged in the Y-axis direction.

That is, in the case of the present embodiment, the direction in which the second component B2 and the fifth component B5 are arranged is the Z-axis direction, and the direction in which the plurality of blue light beams emitted from the plurality of light emitting units 120 are arranged is the Y-axis direction. Therefore, in the present embodiment, the direction in which the second component B2 and the fifth component B5 are arranged crosses (is orthogonal to) the direction in which the plurality of blue light beams emitted from the plurality of light emitting units 120 are arranged.

As described above, in the light separation element 30 in the present embodiment, since the luminous fluxes LB12, LB15, BL22, and BL25 of the blue illumination light BL2 separated from the blue light BL do not overlap each other, it is possible to improve the uniformity of the illuminance distribution of the blue illumination light BL2. Therefore, the illuminance unevenness of the blue illumination light BL2 can efficiently be suppressed.

As described above, the blue illumination light BL2 is diffusely reflected by the diffuse reflection element 23, is transmitted through the light separation element 30, and is incident on the integrator optical system 28. That is, the second component B2 and the fifth component B5 reflected by the diffuse reflection element 23 are transmitted through the light separation element 30, and combined with the fluorescence YL reflected by the second optical layer 32 to be emitted as the illumination light WL in the same direction.

In the description using FIG. 3, the model is simplified without considering the refraction of the light at the time of incidence or the time of exit with respect to the light separation element 30, but in order to arrange the second component B2 and the fifth component B5 so as not to overlap each other, it is necessary to consider the refraction of the light in the light-transmissive substrate 33.

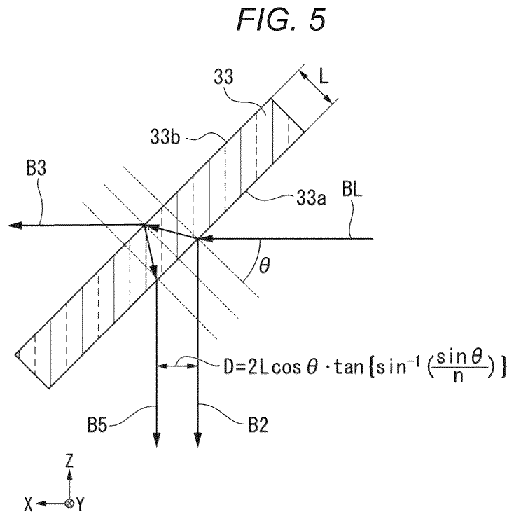

FIG. 5 is a diagram illustrating a behavior of light when taking the refraction in the light-transmissive substrate 33 into consideration. Note that in FIG. 5, the illustration of the first optical layer 31 and the second optical layer 32 is omitted.

In FIG. 5, the incident angle of the blue light BL with respect to the first surface 33a of the light-transmissive substrate 33 is denoted by θ, the refractive index of the light-transmissive substrate 33 is denoted by n, the thickness of the light-transmissive substrate 33 is denoted by L, and an interval between the second component B2 and the fifth component B5 is denoted by D.

As shown in FIG. 5, the interval D between the second component B2 and the fifth component B5 is defined by the expression described therein. For example, when the interval between the first luminous flux LB1 and the second luminous flux LB2 shown in FIG. 4 is 6.36 mm, in order to prevent the luminous fluxes LB12, LB15, LB22, and LB25 from overlapping each other as described above, the light-transmissive substrate 33 may be designed such that the interval D between the second component B2 and the fifth component B5 is 3.18 mm which is half of 6.36 mm. For example, in the expression described above, when the incident angle θ is 45° as in the illumination device 12 of the present embodiment, for example, assuming that D is 3.18 mm and the refractive index n of the light-transmissive substrate 33 is 1.52, the thickness L of the light-transmissive substrate 33 is 4.28 mm.

Note that, for example, when the light-transmissive substrate 33 is tilted clockwise by θ1, that is, when the incident angle θ is reduced by θ1, the optical axis ax2 is tilted clockwise by 2θ1.

According to the light separation element 30 in the present embodiment, by appropriately setting the parameters such as the incident angle θ, the refractive index n, the thickness L, and the interval D, it is possible to provide a light separation element that emits the blue illumination light BL2 in which illuminance unevenness is suppressed.

As described above, the illumination device 12 according to the present embodiment includes the light source 20 configured to output the blue light BL in the blue wavelength band, the light separation element 30 configured to separate the blue light BL incident from the light source 20, the wavelength conversion element 25 configured to convert the blue light BL into the fluorescence YL in the yellow wavelength band different from the blue wavelength band, and the diffuse reflection element 23 configured to reflect, toward the light separation element 30, the blue light BL incident from the light separation element 30. The light separation element 30 includes the light-transmissive substrate 33 having the first surface 33a and the second surface 33b parallel to each other and facing to respective directions opposite to each other, the first optical layer 31 that is disposed at the first surface 33a, transmits the first component B1 that is a part of the blue light BL incident from the light source 20, and reflects the second component B2 that is another part of the blue light BL, and the second optical layer 32 that is disposed at the second surface 33b, transmits the third component B3 that is a part of the first component B1 transmitted through the first surface 33a and reaching the second surface 33b, and reflects the fourth component B4 that is another part of the first component B1. The blue light BL is incident on the first surface 33a of the light-transmissive substrate 33 from the X-axis direction crossing the direction along the principal surface of the first surface 33a and the normal direction of the principal surface, and the first optical layer 31 transmits the fifth component B5, which is a part of the fourth component B4 incident from the second optical layer 32. The second component B2 reflected by the first optical layer 31 and the fifth component B5 transmitted through the first optical layer 31 are incident on the diffuse reflection element 23.

According to the illumination device 12 of the present embodiment, the blue light BL incident from the light source 20 can be separated into the excitation light BL1 as a transmission component and the blue illumination light BL2 as a reflection component in the light separation element 30. Therefore, according to the illumination device 12 of the present embodiment, since the blue light BL is transmitted or reflected to thereby separate the light path into two, it is possible to provide an illumination device having a high degree of freedom in designing the light path.

Further, since the light separation element 30 separates the blue illumination light BL2 from the blue light BL by reflecting the second component B2 and the fifth component B5, it is possible to increase the number of blue light beams forming the blue illumination light BL2. Accordingly, it is possible to suppress illuminance unevenness of the blue illumination light BL2 separated from the blue light BL formed of the laser beam.

Therefore, according to the illumination device 12 of the present embodiment, it is possible to generate the illumination light WL obtained by combining the blue illumination light BL2 illuminance unevenness of which is suppressed and the fluorescence YL having a uniform illuminance distribution with each other. Therefore, the illumination target can be illuminated with light having a uniform illuminance distribution.

The projector 1 according to the present embodiment includes the illumination device 12, the light modulation devices 4R, 4G, and 4B configured to modulate the light incident from the illumination device 12, and the projection optical device 16 configured to project the light modulated by the light modulation devices 4R, 4G, and 4B.

According to the projector 1 of the present embodiment, by modulating the illumination light WL which is small in illuminance unevenness and is incident from the illumination device 12, it is possible to project an image which is bright, high-quality, and small in color unevenness.

### Second Embodiment

Then, a second embodiment of the present disclosure will be described with reference to the drawings.

The present embodiment is different in the configuration of the illumination device from the first embodiment, and other configurations are common to the present embodiment and the first embodiment. Therefore, the configuration of the illumination device will mainly be described below, and the description of the other configurations will be omitted or simplified. In addition, configurations and members common to the embodiment described above will be described attaching the same reference numerals.

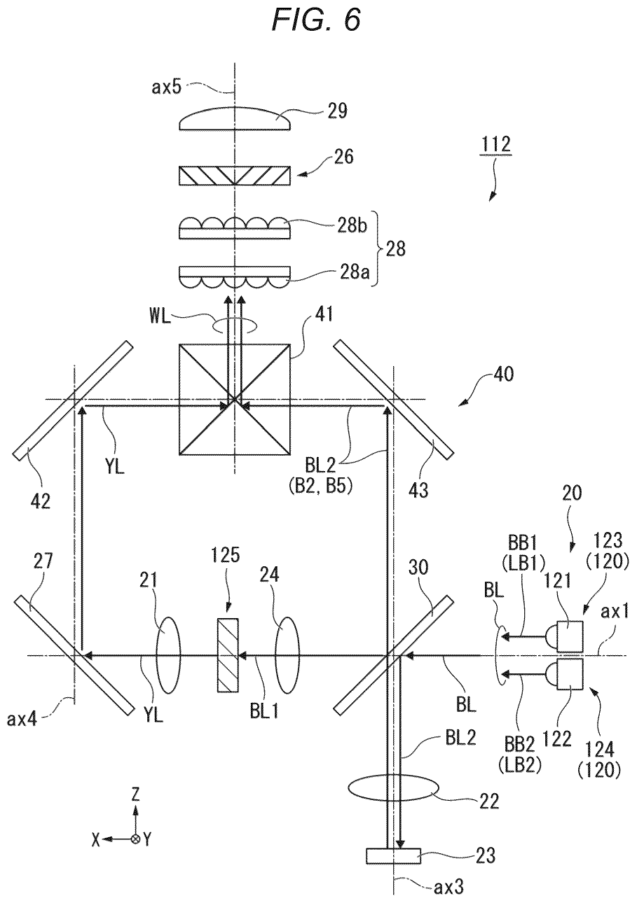

FIG. 6 is a diagram illustrating a schematic configuration of the illumination device of the present embodiment.

As shown in FIG. 6, the illumination device 112 according to the present embodiment includes the light source 20, the light separation element 30, the first pickup optical system 22, the diffuse reflection element 23, the second pickup optical system 24, a wavelength conversion element 125, a third pickup optical system 21, the integrator optical system 28, the polarization conversion element 26, the superimposing lens 29, a mirror 27, and a combining optical system 40. The combining optical system 40 includes a combining prism 41, a first mirror 42, and a second mirror 43.

The illumination device 112 in the present embodiment has optical axes ax3, ax4, and ax5 which are along the Z axis, and orthogonal to the optical axis ax1.

In the elements described above, the light source 20, the light separation element 30, the second pickup optical system 24, the wavelength conversion element 125, the third pickup optical system 21, and the mirror 27 are arranged side by side on the optical axis ax1. The mirror 27 in the present embodiment corresponds to an example of a “second reflection element” in the present disclosure.

The diffuse reflection element 23, the first pickup optical system 22, the light separation element 30, and the second mirror 43 of the combining optical system 40 are disposed side by side on the optical axis ax3.

The combining prism 41 of the combining optical system 40, the integrator optical system 28, the polarization conversion element 26, and the superimposing lens 29 are arranged side by side on the optical axis ax5.

The wavelength conversion element 125 in the present embodiment emits the fluorescence YL toward the mirror 27 at an opposite side to the light separation element 30. That is, the wavelength conversion element 125 in the present embodiment emits the fluorescence YL toward an opposite direction to the incident side of the excitation light BL1.

The fluorescence YL emitted from the wavelength conversion element 125 enters the third pickup optical system 21. The third pickup optical system 21 collimates the fluorescence YL and causes the fluorescence YL thus collimated to enter the mirror 27. The third pickup optical system 21 is formed of a single lens or a plurality of lenses.

The mirror 27 reflects the fluorescence YL toward the Z-axis direction in which the blue illumination light BL2 including the second component B2 and the fifth component B5 reflected by the diffuse reflection element 23 and transmitted through the light separation element 30 travels.

The fluorescence YL reflected by the mirror 27 is reflected by the first mirror 42 of the combining optical system 40 to enter the combining prism 41. The blue illumination light BL2 is reflected by the second mirror 43 of the combining optical system 40 to enter the combining prism 41. The combining prism 41 outputs the illumination light WL obtained by combining the fluorescence YL and the blue illumination light BL2 toward the integrator optical system 28.

Also in the illumination device 112 according to the present embodiment, since the illumination light WL is generated by separating the light path of the blue light BL into two by transmitting or reflecting the blue light BL and then recombining the fluorescence YL and the blue illumination light BL2, it is possible to provide an illumination device having a high degree of freedom in designing the light path. Further, similarly to the illumination device 12 of the first embodiment, when separating the blue illumination light BL2, the number of blue light beams forming the blue illumination light BL2 can be increased, and therefore, the illuminance unevenness of the blue illumination light BL2 can be suppressed. Therefore, also in the illumination device 112 according to the present embodiment, it is possible to generate the illumination light WL obtained by combining the blue illumination light BL2 illuminance unevenness of which is suppressed and the fluorescence YL having a uniform illuminance distribution. Therefore, the illumination target can be illuminated with light having a uniform illuminance distribution.

Note that although when the illumination device 112 according to the present embodiment combines the fluorescence YL and the blue illumination light BL2 with each other using the combining optical system 40 and then cause the light thus combined to enter the integrator optical system 28 is cited as an example, it is possible to arrange that the fluorescence YL and the blue illumination light BL2 are emitted toward the Z-axis direction without using the combining optical system 40. On this occasion, the fluorescence YL is directly incident on the first dichroic mirror 7a of the color separation optical system 13 shown in FIG. 1, and the blue illumination light BL2 is directly incident on the third reflecting mirror 8c of the color separation optical system 13.

The technical scope of the present disclosure is not limited to the embodiments described above, and various modifications can be made therein without departing from the spirit and scope of the present disclosure.

For example, in the embodiments described above, when the diffuse reflection element 23 is used as the first reflection element that reflects the blue illumination light BL2 toward the light separation element 30 has been cited as an example, but a mirror that simply reflects light without diffusing the light may be used.

Further, in the embodiments described above, when the laser elements are used as the plurality of light emitting units 120 of the light source 20 that emits the blue light BL has been cited as an example, but light emitting diodes may be used.

In addition, the specific descriptions of the shapes, the numbers, the arrangements, the materials, and the like of the elements of the illumination device and the projector are not limited to those in the embodiments described above, and can be changed as appropriate.

The present disclosure will be summarized below as appendices.

### Appendix 1

An illumination device including:
a light source configured to emit first light in a first wavelength band;
a light separation element configured to separate the first light incident from the light source into transmitted light and reflected light;
a wavelength conversion element configured to convert the transmitted light separated by the light separation element into second light in a second wavelength band different from the first wavelength band; and
a first reflection element configured to reflect, toward the light separation element, the reflected light separated by the light separation element, in which
the light separation element includes
a light-transmissive substrate having a first surface and a second surface that are parallel to each other and face to respective directions opposite to each other,
a first optical layer that is disposed at the first surface, transmits a first component that is a part of the first light incident from the light source, and reflects a second component that is another part of the first light, and
a second optical layer that is disposed at the second surface, transmits a third component that is a part of the first component that was transmitted through the first surface and reached the second surface, and reflects a fourth component that is another part of the first component,
the first light is incident on the first surface of the light-transmissive substrate from a direction crossing a direction along a principal surface of the first surface and a normal direction of the principal surface,
the first optical layer is configured to transmit a fifth component that is a part of the fourth component incident from the second optical layer, and
the second component reflected by the first optical layer and the fifth component transmitted through the first optical layer are incident on the first reflection element as the reflected light.

According to the illumination device having this configuration, since the first light incident from the light source is transmitted and reflected by the light separation element to separate the light path of the first light into two, it is possible to provide an illumination device high in degree of freedom in designing the light path of the first light.

Further, since the light separation element reflects the second component and the fifth component from the first light to separate the reflected light, the number of light beams forming the reflected light can be increased. Therefore, the illuminance unevenness of the reflected light separated from the first light can be suppressed. Therefore, according to the illumination device having this configuration, the illumination target can be illuminated with light having a uniform illuminance distribution.

### Appendix 2

The illumination device according to Appendix 1, in which
the second optical layer has an optical characteristic of reflecting the second light, and
the second light enters the second surface in an oblique direction from the wavelength conversion element, and is reflected by the second optical layer disposed at the second surface to be emitted in a direction different from a direction in which the second light enters the second optical layer.

According to this configuration, the light path of the second light can be deflected in the second optical layer to extract the second light in a desired direction.

### Appendix 3

The illumination device according to Appendix 2, in which
the reflected light reflected by the first reflection element is transmitted through the light separation element, and is combined with the second light reflected by the second optical layer to be emitted in a same direction as illumination light.

According to this configuration, the illumination light including the second light and the reflected light including the second component and the fifth component can be combined by the light separation element and extracted in one direction.

### Appendix 4

The illumination device according to Appendix 3, in which
the first reflection element is a diffuse reflection element configured to diffusely reflect incident light.

According to this configuration, by diffusely reflecting the second component and the fifth component, the uniformity of the illuminance distribution in the reflected light can further be enhanced.

### Appendix 5

The illumination device according to any one of Appendices 1 to 4, in which
a reflectance of the first light in the second optical layer is higher than a reflectance of the first light in the first optical layer.

According to this configuration, the proportion of the first light that reaches the second optical layer can be increased by increasing the transmittance of the first light in the first optical layer. Accordingly, it is possible to prevent the light amount of the second component from becoming excessively higher than the light amount of the fifth component.

### Appendix 6

The illumination device according to any one of Appendices 1 to 5, in which
a ratio in light amount between the second component and the fifth component contained in the reflected light is in a range of 50% to 200%.

According to this configuration, it is possible to prevent the difference in light amount between the second component and the fifth component in the reflected light from becoming too large, and it is possible to prevent the occurrence of a problem that the illuminance unevenness of the reflected light increases to thereby degrade the quality of the projected image.

### Appendix 7

The illumination device according to any one of Appendices 1 to 6, in which
the light source includes a plurality of light emitting units configured to emit the first light, and
a direction in which the second component and the fifth component are arranged in the reflected light crosses a direction in which a plurality of light beams emitted from the plurality of light emitting units are arranged.

According to this configuration, since the plurality of light beams forming the reflected light is arranged in a balanced manner, it is possible to suppress illuminance unevenness of the reflected light in a balanced manner.

### Appendix 8

The illumination device according to Appendix 7, in which
the plurality of light emitting units includes a first light emitting unit array in which a plurality of first light emitting units are arranged, and a second light emitting unit array which is disposed in parallel to the first light emitting unit array, and in which a plurality of second light emitting units are arranged, and
in the reflected light, each of the fifth components in the first light emitted from the first light emitting unit array and the second light emitting unit array is shifted in a direction in which the second components in the first light emitted from the first light emitting unit array and the second light emitting unit array are arranged, and is disposed at a position not overlapping each of the second components.

According to this configuration, since the light beams forming the reflected light separated from the first light are arranged without overlapping each other, it is possible to improve the uniformity of the illuminance distribution of the reflected light. Therefore, the illuminance unevenness of the reflected light can efficiently be suppressed.

### Appendix 9

The illumination device according to any one of Appendices 1 to 8, in which
the wavelength conversion element emits the second light toward a second reflection element at an opposite side to the light separation element, and
the second reflection element reflects the second light toward a direction in which the reflected light including the second component and the fifth component that were reflected by the first reflection element and were transmitted through the light separation element travels.

According to this configuration, it is possible to provide a configuration in which the second light and the reflected light are emitted in the same direction in the configuration in which the second light is emitted to the opposite side to the light separation element.

### Appendix 10

A projector including:
the illumination device according to any one of Appendices 1 to 9;
a light modulation device configured to modulate light incident from the illumination device; and
a projection optical device configured to project the light modulated by the light modulation device.

According to the projector having this configuration, it is possible to project a high-quality image which is bright and is little in color unevenness by modulating the illumination light which is incident from the illumination device and is little in illuminance unevenness.

What is claimed is:

1. An illumination device comprising:
a light source configured to emit first light in a first wavelength band;
a light separation element configured to separate the first light incident from the light source into transmitted light and reflected light;
a wavelength conversion element configured to convert the transmitted light separated by the light separation element into second light in a second wavelength band different from the first wavelength band; and
a first reflection element configured to reflect, toward the light separation element, the reflected light separated by the light separation element, wherein
the light separation element includes
a light-transmissive substrate having a first surface and a second surface that are parallel to each other and face to respective directions opposite to each other,
a first optical layer that is disposed at the first surface, transmits a first component that is a part of the first light incident from the light source, and reflects a second component that is another part of the first light, and
a second optical layer that is disposed at the second surface, transmits a third component that is a part of the first component that was transmitted through the first surface and reached the second surface, and reflects a fourth component that is another part of the first component,
the first light is incident on the first surface of the light-transmissive substrate from a direction crossing a direction along a principal surface of the first surface and a normal direction of the principal surface,
the first optical layer is configured to transmit a fifth component that is a part of the fourth component incident from the second optical layer, and
the second component reflected by the first optical layer and the fifth component transmitted through the first optical layer are incident on the first reflection element as the reflected light.

2. The illumination device according to claim 1, wherein
the second optical layer has an optical characteristic of reflecting the second light, and
the second light enters the second surface in an oblique direction from the wavelength conversion element, and is reflected by the second optical layer disposed at the second surface to be emitted in a direction different from a direction in which the second light enters the second optical layer.

3. The illumination device according to claim 2, wherein
the reflected light reflected by the first reflection element is transmitted through the light separation element, and is combined with the second light reflected by the second optical layer to be emitted in a same direction as illumination light.

4. The illumination device according to claim 3, wherein
the first reflection element is a diffuse reflection element configured to diffusely reflect incident light.

5. The illumination device according to claim 1, wherein
a reflectance of the first light in the second optical layer is higher than a reflectance of the first light in the first optical layer.

6. The illumination device according to claim 1, wherein
a ratio in light amount between the second component and the fifth component contained in the reflected light is in a range of 50% to 200%.

7. The illumination device according to claim 1, wherein
the light source includes a plurality of light emitting units configured to emit the first light, and
a direction in which the second component and the fifth component are arranged in the reflected light crosses a direction in which a plurality of light beams emitted from the plurality of light emitting units are arranged.

8. The illumination device according to claim 7, wherein
the plurality of light emitting units includes a first light emitting unit array in which a plurality of first light emitting units are arranged, and a second light emitting unit array which is disposed in parallel to the first light emitting unit array, and in which a plurality of second light emitting units are arranged, and
in the reflected light, each of the fifth components in the first light emitted from the first light emitting unit array and the second light emitting unit array is shifted in a direction in which the second components in the first light emitted from the first light emitting unit array and the second light emitting unit array are arranged, and is disposed at a position not overlapping each of the second components.

9. The illumination device according to claim 1, wherein
the wavelength conversion element emits the second light toward a second reflection element at an opposite side to the light separation element, and
the second reflection element reflects the second light toward a direction in which the reflected light including the second component and the fifth component that were reflected by the first reflection element and were transmitted through the light separation element travels.

10. A projector comprising:
the illumination device according to claim 1;
a light modulation device configured to modulate light incident from the illumination device; and
a projection optical device configured to project the light modulated by the light modulation device.
